(19) United States
(12) Patent Application Publication
(10) Pub. No.: US 2026/0048596 A1
(43) Pub. Date: Feb. 19, 2026

(54) RECORDING APPARATUS

(71) Applicant: CANON KABUSHIKI KAISHA, Tokyo (JP)

(72) Inventor: RYOSUKE UEMURA, Fukuoka (JP)

(21) Appl. No.: 19/297,160

(22) Filed: Aug. 12, 2025

(30) Foreign Application Priority Data
Aug. 19, 2024 (JP) 2024-137823

(51) Int. Cl. B41J 11/00; B41J 11/66; B41M 7/00

(52) U.S. Cl. CPC B41J 11/00222; B41J 11/006; B41J 11/0095; B41J 11/66; B41M 7/009

(57) ABSTRACT

A recording apparatus includes a recording unit that records an image on a recording medium, a conveyance unit that conveys the recording medium, a fixing unit that is disposed downstream of the recording unit in a conveyance direction of the recording medium and heats, at a first temperature, the recording medium on which the image has been recorded, and a control unit that controls the fixing unit. When image recording in a recording area by the recording unit is stopped before the image recording in the recording area by the recording unit is completed, the control unit changes temperature of the fixing unit to a second temperature lower than the first temperature.

### BACKGROUND

### Field of the Technology

The present disclosure relates to a recording apparatus.

### Description of the Related Art

In a recording apparatus that records an image on a sheet using ink and then fixes the ink using a fixing apparatus, a jam error in which the sheet stops during recording or cancellation by a user may occur. Japanese Patent Laid-Open No. 2022-071366 discloses a recording apparatus in which a user can immediately remove a sheet by immediately stopping a sheet conveyance operation and a fixing operation in case that a jam error or user cancellation occurs.

### SUMMARY

The present disclosure provides a recording apparatus comprising:
a recording unit configured to record an image on a recording medium;
a conveyance unit configured to convey the recording medium,
a fixing unit disposed downstream of the recording unit in a conveyance direction of the recording medium and configured to heat, at a first temperature, the recording medium on which the image has been recorded; and
a control unit configured to control the fixing unit, wherein
in case that image recording in a recording area by the recording unit is stopped before the image recording in the recording area by the recording unit is completed, the control unit is configured to change temperature of the fixing unit to a second temperature lower than the first temperature.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic diagram illustrating a relationship between a recording apparatus and an external connection device according to an embodiment.

FIG. 2 is a block diagram illustrating a configuration of the recording apparatus according to the embodiment.

FIG. 3A is a perspective view illustrating an external configuration of a recording unit according to the embodiment.

FIG. 3B is a perspective view illustrating an in-cover configuration of the recording unit according to the embodiment.

FIG. 4 is a schematic diagram illustrating a cross section of a sheet conveyance configuration of the recording unit according to the embodiment.

FIG. 5 is a schematic cross-sectional view illustrating a configuration of an ink fixing apparatus according to the embodiment.

FIG. 6 is a diagram illustrating an ink fixed area and a non-fixed area according to the embodiment.

FIGS. 7A and 7B are diagrams illustrating examples of an abnormal state of a sheet at the time of recording cancellation according to the embodiment.

FIG. 8 is a flow of changing temperature at the time of recording cancellation according to a first embodiment.

FIG. 9 is a flow of changing temperature and speed at the time of recording cancellation according to the first embodiment.

FIG. 10 is a flow of changing an operation at the time of recording cancellation according to the first embodiment.

FIG. 11 is a flow of changing temperature at the time of recording cancellation according to a second embodiment.

### DESCRIPTION OF THE EMBODIMENTS

Embodiments of the present disclosure will now be described with reference to the accompanying drawings. However, it is to be understood that dimensions, materials, shapes, relative arrangements, and the like of components described in the embodiments are intended to be changed as appropriate in accordance with configurations and various conditions of apparatuses to which the disclosure is to be applied. Therefore, unless otherwise specified, the scope of the present disclosure is not intended to be limited thereto. While a plurality of features are described in each of the embodiments, all the features are not necessarily essential to the disclosure and the plurality of features may be combined with each other in any way.

According to the inventor's study, when the sheet conveyance operation and the fixing operation are immediately stopped in the recording apparatus, the ink non-fixed portion remains in the recording apparatus. Therefore, when the user removes the sheet, the ink non-fixed portion may contact the recording apparatus, causing the ink to adhere to the inside of the recording apparatus and causing contamination or failure. Therefore, it is needed to provide a technique that a user can remove the sheet without staining the inside of the recording apparatus when recording in the recording apparatus is stopped.

### First Embodiment

### Device Configuration

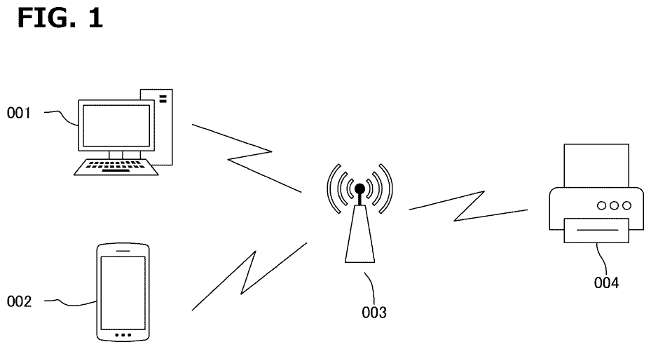

FIG. 1 is a schematic diagram illustrating an example of a relationship between a recording apparatus 004 and an external connection device according to the present embodiment. The recording apparatus 004 is connected to an external connection device via a LAN unit 003. The LAN unit 003 connects the recording apparatus 004 to an external connection device as a server via an interface or a network. For example, image data is transferred from an external connection device such as a personal computer 001 or a smartphone 002 to the recording apparatus 004 via the LAN unit 003. The LAN unit 003 may be able to transmit and receive data regardless of wired or wireless communication.

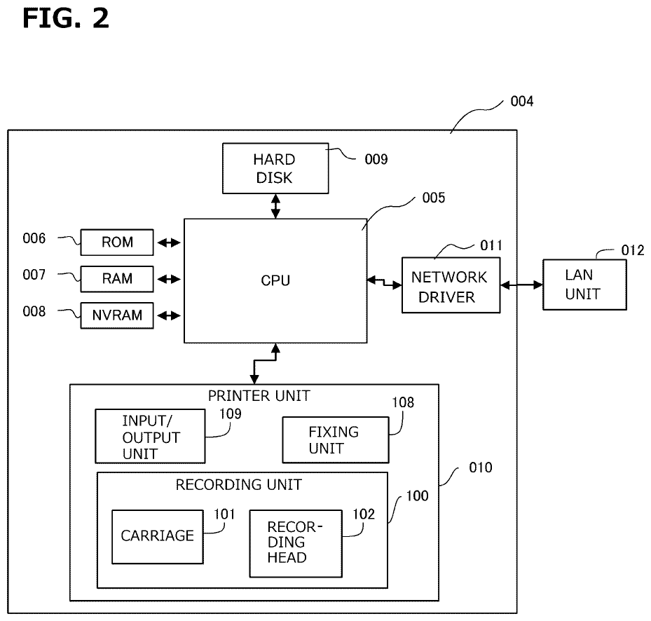

FIG. 2 is a block diagram illustrating a configuration of the recording apparatus 004 according to the present embodiment. The recording apparatus 004 includes a CPU 005 as a control unit and a printer unit 010 for performing recording under control of the CPU 005. The printer unit 010 includes a fixing unit 108 for drying and fixing ink on a sheet, an input/output unit 109, and a recording unit 100 for recording an image. The input/output unit 109 includes a user interface such a liquid crystal display (LCD), a light emitting diode (LED), a key, and a touch panel.

A ROM 006 stores a control execution code (program) of the recording apparatus 004. A RAM 007 stores the recording image data as a temporary storage in the control execution of the recording apparatus 004. An NVRAM 008 is a non-volatile memory, and stores information about the recording of various data necessary for the maintenance of the recording apparatus 004 and the image to be recorded.

A hard disk 009 stores image data to be recorded by the printer unit 010. A network driver 011 exchanges execution instructions and data with external connection devices and servers via a LAN unit 012. For example, when printing is performed by the printer unit 010, image data is transferred from the external connection device via the network driver 011. The recording unit 100 includes a carriage 101 and a recording head 102 for recording an image on a sheet 105.

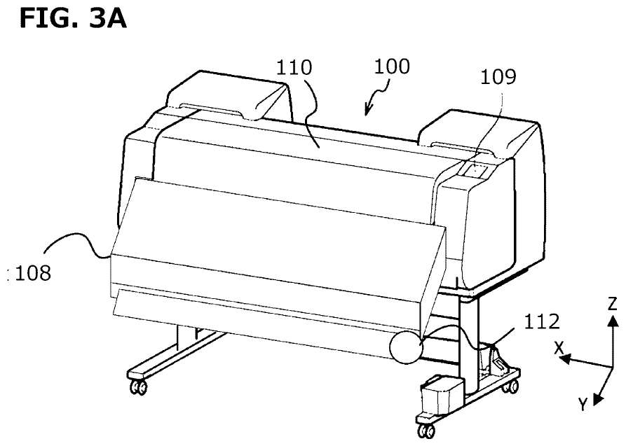

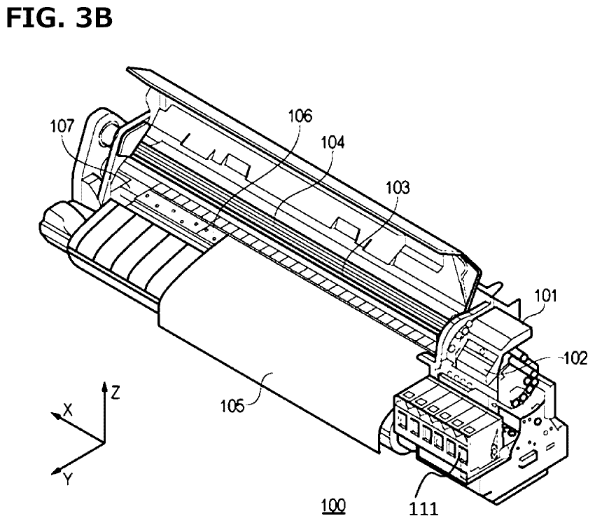

FIGS. 3A and 3B are perspective views illustrating a configuration of the recording unit 100. FIG. 3A illustrates the overall appearance, and FIG. 3B illustrates a state in which a top cover 110 of FIG. 3A is opened to view an internal structure. The recording unit 100 according to the present embodiment performs recording by applying ink droplets as a recording material onto a sheet by an ink-jet recording method. The sheet 105 is conveyed in the Y direction as a conveyance direction.

The carriage 101 on which the recording head 102 is mounted moves back and forth in the X direction which intersects the Y direction to perform recording. In other words, the recording head 102 performs so-called serial recording. However, an ink-jet system having a so-called line type recording head in which a nozzle array is configured across the recording width in the Y-direction may be used. In addition to the recording function, a scan function, a fax function, a transmission function, and the like may be integrated as a multi-function peripheral (MFP).

The input/output unit 109 is provided above the recording unit 100. The input/output unit 109 is an operation panel having a display and keys. When a remaining ink amount and candidates for a type of the sheet 105 are displayed on the display, a user can select a type of the sheet 105, make settings for recording, or cancel the recording by operating the keys. In this case, the input/output unit 109 can also be called a canceling unit.

The recording head 102 is disposed on a surface of the carriage 101, on which a nozzle is provided for ejecting ink supplied from an ink tank 111. The carriage 101 is configured to be reciprocally movable in the X direction (the moving direction of the carriage 101) along a shaft 104 via a carriage belt 103 by drive of a carriage motor.

The sheet 105, such as a sheet roll or a cut sheet, is conveyed in the Y direction on a platen 106 by conveyance rollers. While the carriage 101 moves in the X direction on the sheet 105 conveyed onto the platen 106 by the conveyance rollers, ink droplets are ejected from the recording head 102, thereby performing a recording operation. When the carriage 101 moves to an end of a recording area on the sheet 105, the conveyance rollers convey the sheet 105 by a predetermined amount, and moves the area where the next recording scan is performed to the position where the recording head 102 can record. By repeating the above-described operations, an image is recorded on the sheet 105.

The ink used for the image recording according to the present embodiment is latex ink. When heat is applied to the latex ink, moisture is evaporated, latex resin is mixed with dissolved pigment, and a film is formed on the sheet surface and cured. Although the sheet 105 used in a general aqueous inkjet recording apparatus needs an ink receiving layer to catch ink and prevent smearing, a recording apparatus that uses latex ink can also record on the sheet 105 without the ink receiving layer. According to the present embodiment, the sheet 105 after image recording is conveyed to the fixing unit 108 as a fixing apparatus, and heat is applied to the sheet 105 in the fixing unit, the ink is cured and fixed on the sheet, and the sheet is discharged from the fixing unit 108. After the sheet 105 is discharged from the fixing unit 108, if a cutting process is needed, the cutting process is performed by a cutter 112.

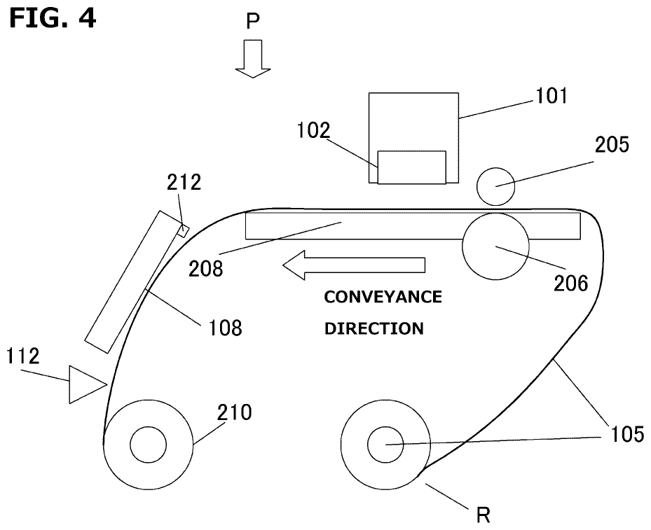

FIG. 4 is a schematic diagram illustrating a cross section of a sheet conveyance configuration of the recording apparatus 004. The sheet 105 is supported by conveyance rollers 205 and 206, which serve as a conveyance unit, at the upper and lower sides. As the conveyance rollers 205 and 206 rotate, the sheet 105 is conveyed in the conveyance direction. According to the present embodiment, in the conveyance direction of the sheet 105 along a conveyance path, the side near a sheet roll R is referred to as an upstream side, and the side near a winding unit 210 is referred to as a downstream side. The sheet 105 is supported by the platen 208 from below. Note that the recording medium is not limited to the sheet roll R, and cut sheets may be used. In a case where the recording medium is a sheet roll, the sheet is set in the device in a wound state and drawn out of the roll and used as the recording proceeds.

The recording unit 100 included in the printer unit 010 of the recording apparatus 004 includes the carriage 101 on which the recording head 102 is mounted. Recording is performed by the recording head 102 ejecting ink from the nozzle while the carriage 101 performs scanning. On the recorded sheet 105, the ink is fixed in the fixing unit 108. After the ink is fixed, the sheet 105 is wound up by a winding unit 210, and is cut by the cutter 112 when a cutting process is needed. A sheet detection sensor 212 as a detection unit is installed near the fixing unit to detect whether or not the sheet 105 approaches the fixing unit 108. When the sheet 105 comes close enough to come into contact with the fixing unit 108, the sheet detection sensor 212 determines that there is a sheet and notifies the control unit of the state of the sheet 105. In other words, when the sheet 105 is likely to contact the fixing unit 108, it is detected that the sheet state is abnormal.

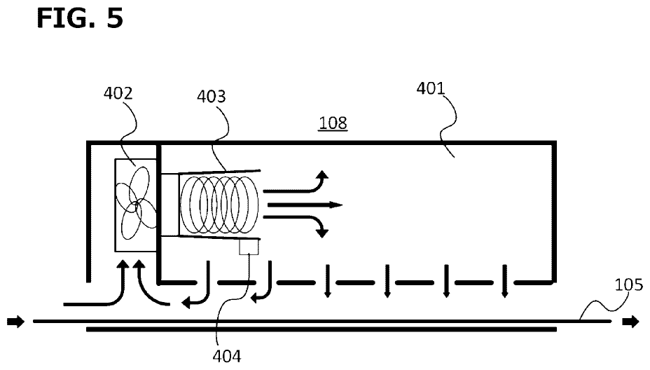

FIG. 5 is a schematic cross-sectional view illustrating a configuration of the fixing unit 108 for ink fixing. In this figure, it is assumed that the sheet 105 is fed from the left side of the figure and discharged to the right side as shown by the black arrows.

A chamber 401 includes an axial flow type blower fan 402 for taking in and blowing outside air, and a heater 403 for heating the blowing air from the blower fan 402 to turn the air into dry air, and the dry air is blown from an opening of the chamber 401 to contribute to fixing of ink. The heater 403 includes a temperature sensor 404. The CPU 005 can perform stable heater temperature control based on temperature feedback from the temperature sensor 404. Here, the ink is fixed in a non-contact manner by a combination of the blower fan 402 and the heater 403 and dry air, but a configuration using a contact heater or a radiant heater may be used.

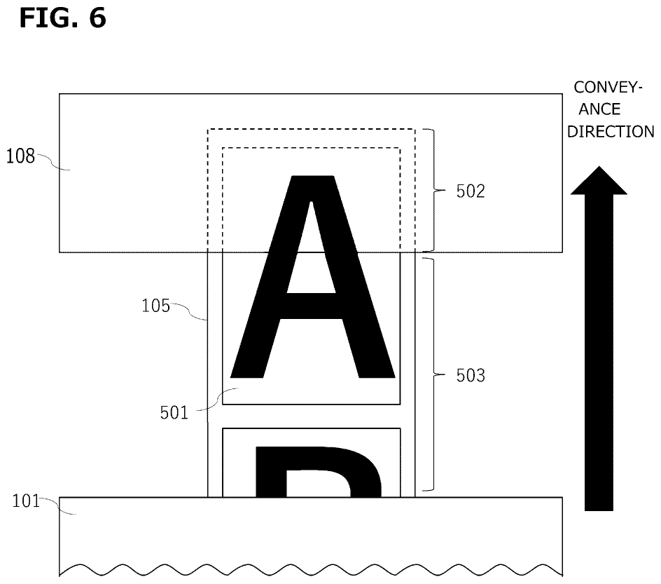

FIG. 6 is a view illustrating an ink fixed area and a non-fixed area and illustrating a state where the sheet 105 placed in the area between the recording head 102 and the fixing unit 108 is viewed from a direction orthogonal to the conveyance direction (the arrow P in FIG. 4). As described above, the recording unit 100 carries out recording by ejecting ink from the nozzle of the recording head 102 mounted on the carriage 101 while conveying the sheet 105 in the sheet conveyance direction. When the conveyance of the sheet 105 and the ejection of the ink are repeated, the recorded portion of the sheet 105 is conveyed to below the fixing unit 108. Then, the fixing unit 108 sequentially fixes the ink by the above-described fixing method.

It is assumed that the user cancels the recording using the input/output unit 109 in the state illustrated in FIG. 6. At this time, when the conveyance of the sheet 105 and the ejection of the ink are immediately stopped, the ink in a recording area 502 can be fixed to the sheet 105 by the heat of the fixing unit 108. Therefore, the recording area 502 is also referred to as an ink fixed area 502. On the other hand, since the ink in a recording area 503 does not reach below the fixing unit 108, the ink is not fixed to the sheet 105. This recording area 503 is also referred to as an ink non-fixed area 503. In other words, in the state illustrated in FIG. 6, one image 501 to be recorded includes the ink fixed area 502 and the ink non-fixed area 503.

When the user tries to remove, from the recording apparatus, the sheet 105 on which the ink non-fixed area 503 remains, the ink in the ink non-fixed area 503 may come into contact with the recording apparatus. This may result in staining the internal structure or causing failure of the recording apparatus 004. Accordingly, even when the user cancels the recording, it is needed to continue the conveying and fixing operations of the sheet 105 to fix the ink in the ink non-fixed area 503 to the sheet 105.

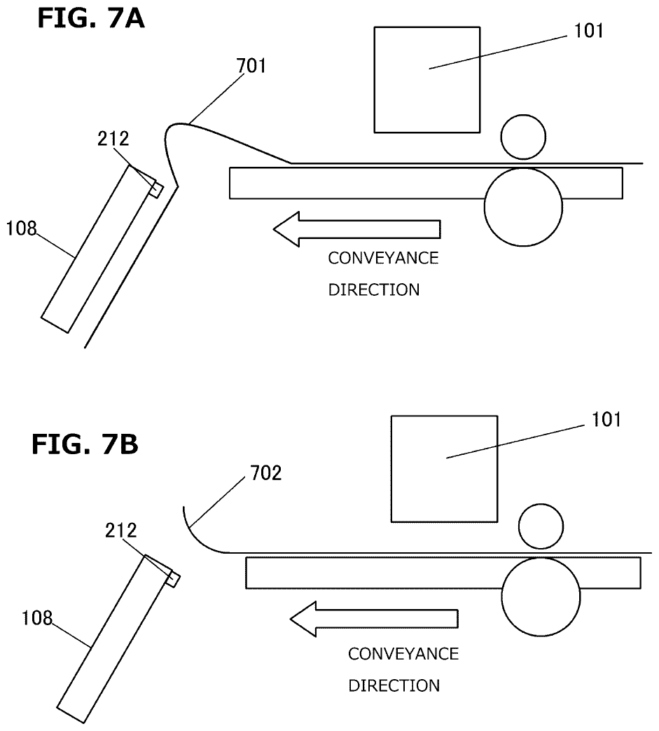

FIGS. 7A and 7B are diagrams illustrating examples of an abnormal state of the sheet 105 in a case where the recording is canceled according to the present embodiment. FIG. 7A illustrates a state in which the sheet 105 in the ink non-fixed area 503 is bent at the time of recording cancellation. FIG. 7B illustrates a state in which a leading end of the sheet 105 in the ink non-fixed area 503 is curled at the time of recording cancellation. The fact that the user has performed the cancellation during recording may indicate that some abnormality such as bending or curling has occurred in the sheet 105. Alternatively, the sheet 105 may be jammed.

When the sheet 105 is conveyed for the ink fixing operation in a state where the sheet 105 has a bent portion 701 as illustrated in FIG. 7A, the bent portion 701 may contact the fixing unit 108. Since the fixing unit 108 has a high temperature for fixing, the sheet 105 may be damaged. Also, in the case where the leading end 702 of the sheet 105 is curled as illustrated in FIG. 7B or a tail end of the sheet 105 is curled, the leading end or tail end of the sheet 105 may come into contact with the fixing unit 108 in the same manner.

### First Flow

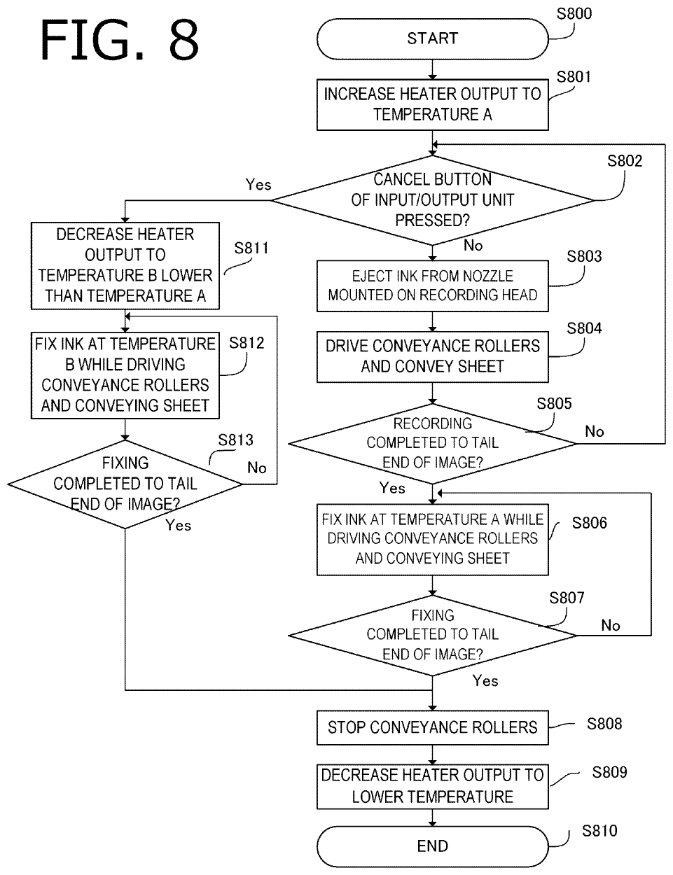

FIG. 8 is a flowchart illustrating an example of processing of changing a fixation temperature at the time of recording cancellation according to the first embodiment. Each of the following steps is performed by the CPU 005 controlling each unit of the device. First, in step S800, when the recording apparatus 004 receives image data, processing is started.

In step S801, the temperature of the fixing unit 108 is raised to a predetermined temperature A (predetermined first temperature). In step S802, it is detected that a cancel button of the input/output unit 109 is pressed by the user. When it is not detected that the cancel button is pressed (S802=No), ink is ejected from the nozzle mounted on the recording head 102 in step S803. In step S804, the conveyance rollers are driven to covey the sheet 105, and recording is performed. It is determined whether the recording is completed to the tail end portion of the received image data in step S805, and if it is not completed (S805=No), the detection in step S802, the ink ejection in step S803, and the conveyance of the sheet 105 in step S804 are repeated.

On the other hand, when the recording is completed to the tail end portion of the image data in step S805 (S805=Yes), the conveyance rollers are driven to convey the sheet 105 while keeping the temperature of the fixing unit 108 at the temperature A, and the ink is fixed (step S806). In step S807, it is determined whether the fixing of the ink to the tail end portion of the image data is completed, and if it is not completed (S807=No), step S806 is continued. When the fixing of the ink to the tail end of the image data is completed (S807=Yes), the conveyance rollers are stopped in step S808, the temperature of the fixing unit 108 is lowered in step S809, and the processing is terminated in step S810. Note that when the recording apparatus is set to cut the sheet 105 with a cutter, the conveyance rollers are stopped in step S808, and the sheet 105 is cut at a predetermined cutting position. Here, the cutting position is a position upstream of an area where the image is recorded in the conveyance direction, and may include a predetermined margin.

Then, when it is detected in step S802 that the cancel button is pressed (S802=Yes), there is a possibility that an abnormality has occurred in the sheet 105 as illustrated in FIGS. 7A and 7B, and when fixing is performed by a fixing unit 108 at a temperature A, the sheet 105 may be damaged. Therefore, even if the image recording on the recording area is not completed, it is necessary to stop the recording of the image by the recording unit. Then, in step S811, the temperature of the fixing unit 108 is lowered until the temperature reaches a temperature B (second temperature) lower than the temperature A. The temperature B is a temperature at which the sheet 105 is not damaged. Thereafter, in step S812, while keeping the temperature of the fixing unit 108 at the temperature B, the conveyance rollers are driven to convey the sheet 105, and ink is fixed. It is determined in step S813 whether the fixing is completed to the tail end portion of the image data, and if it is not completed (S813=No), step S812 is continued. Note that the “tail end portion of image data” in S813 refers to the portion recorded last before the cancel stop of the image recording.

On the other hand, when the fixing of the ink to the tail end portion of the image data is completed (S813=Yes), the conveyance rollers are stopped in step S808, the temperature of the fixing unit 108 is lowered in step S809, and the processing is terminated in step S810. In a case where the recording apparatus is set so that the cutter cuts the sheet 105, after the recorded area of the sheet 105 is conveyed to the position of the cutter by the conveyance rollers, the sheet 105 is cut at a predetermined cutting position. Thus, the recording medium can be cut on the upstream side of the area where the image is recorded. It should be noted that the cancellation of the image recording may result in some abnormality in the sheet 105, and therefore, after the stop of the conveyance, a display for prompting the user to manually cut the sheet 105 may be displayed. If the processing has passed through step S812, even if the sheet 105 comes into contact with the fixing unit 108, the sheet is not damaged. Furthermore, since the ink is fixed to the sheet 105, the ink does not adhere to the inside of the recording apparatus when the user takes out the sheet 105 after the processing is finished in step S810.

### Second Flow

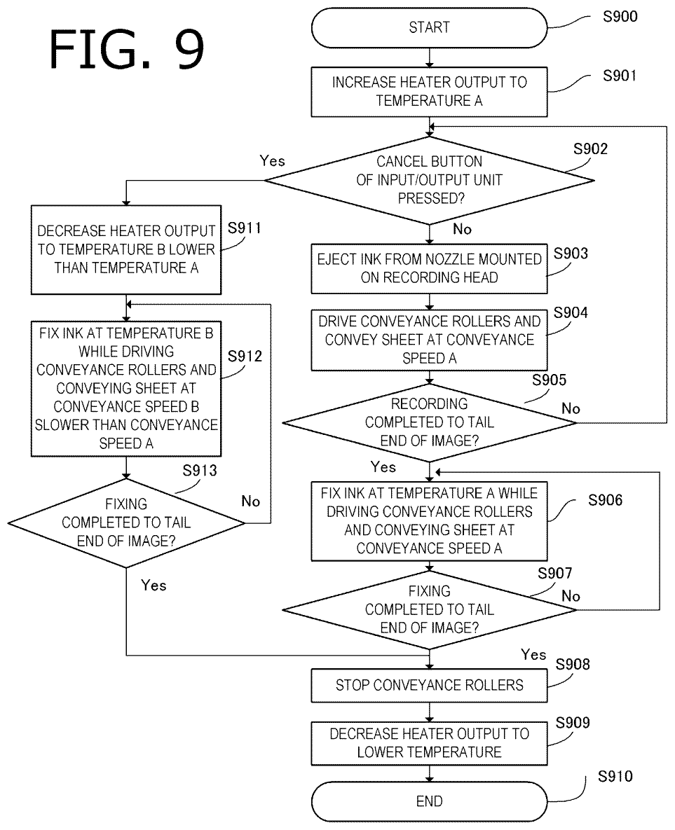

FIG. 9 is a flowchart illustrating the processing of changing the fixation temperature and the conveyance speed of the sheet 105 when the recording is canceled in the first embodiment. The same processing as those in FIG. 8 will be explained briefly. Each of the following steps is performed by the CPU 005 controlling each part of the device. First, in step S900, when the recording apparatus 004 receives image data, processing is started. Thereafter, the heater temperature rise in step S901, the button pressing operation detection in step S902, and the ink ejection in step S903 are similar to S801 to S803 in FIG. 8.

In step S904, the conveyance rollers are driven to convey the sheet 105 at a conveyance speed A (first speed) to perform recording. It is determined in step S905 whether the recording is completed to the tail end portion of the received image data, and if it is not completed, the detection in S902, the ink ejection in S903, and the conveyance of the sheet 105 in S904 are repeated. When recording is completed to the tail end of the image data in S905, the sheet 105 is conveyed by driving the conveyance rollers while keeping the temperature of the fixing unit 108 at the temperature A and the conveyance speed of the sheet 105 at the speed A, and the ink is fixed (step S906).

After that, the ink fixation determination in step S907, the conveyance stop in step S908, the heater temperature drop in step S909, and the termination processing in step S910 are similar to S807 to S810 in FIG. 8.

Then, when it is detected that the cancel button is pressed in S902 (S902=Yes), the temperature of the fixing unit 108 is lowered until it reaches a temperature B lower than the temperature A in S911. Here, if an abnormality such as deflection or breakage of a part of the sheet 105 occurs as illustrated in FIGS. 7A and 7B, the conveyance speed of the sheet 105 may be lowered than usual to suppress the deterioration of the state of the sheet 105, or, in some cases, the abnormality of the sheet 105 may be eliminated. Then, in step S912, the temperature of the fixing unit 108 is kept at the temperature B, and at the same time, the conveyance speed of the sheet 105 is lowered to a conveyance speed B (second speed) slower than the conveyance speed A, and the sheet 105 is conveyed by driving the conveyance rollers to fix the ink.

It is determined in step S913 whether the fixing is completed to the tail end portion of the image data, and if it is not completed (S913=No), the processing in step S912 is continued. When the fixing of the ink to the tail end of the image data is completed (S913=Yes), the conveyance rollers are stopped in step S908, the temperature of the fixing unit 108 is lowered in step S909, and the processing is terminated in step S910. With the processing of this flow, the ink is not adhered to the inside of the recording apparatus, and the possibility of damaging the sheet 105 can be further reduced.

### Third Flow

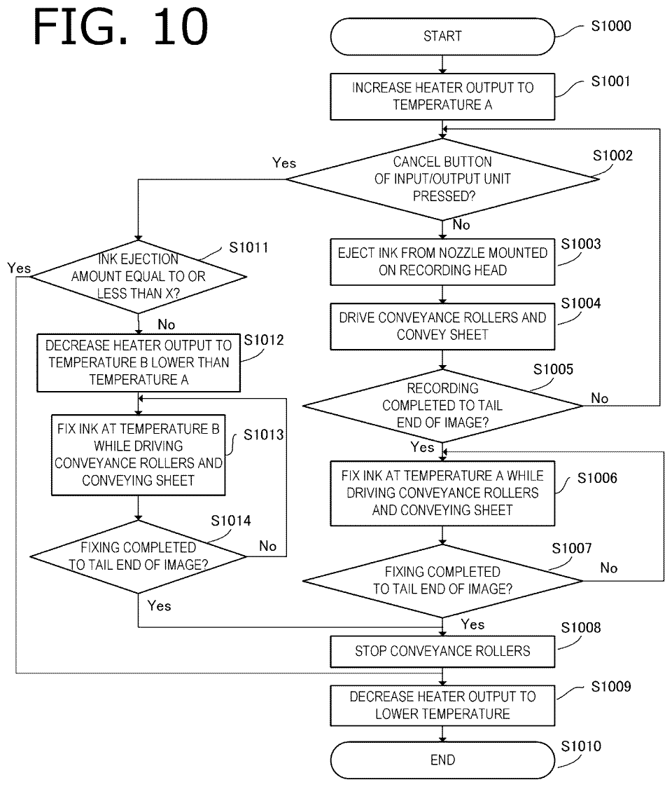

FIG. 10 is a flowchart illustrating the processing of changing the subsequent operation according to an ink ejection amount when the recording is canceled in the first embodiment. The same processing as those in FIGS. 8 and 9 will be explained briefly. Each of the following steps is performed by the CPU 005 controlling each part of the device. First, in step S1000, when the recording apparatus 004 receives image data, processing is started.

Thereafter, the heater temperature rise in step S1001 and the button pressing operation detection in step S1002 are similar to those in FIG. 8. Furthermore, a series of processing if no cancel button pressing is detected (S1002=No) is similar to those in FIG. 8. In other words, the ink ejection in step S1003, the sheet conveyance in step S1004, and the recording detection at the tail end of the image in step S1005 are similar to those in FIG. 8. Furthermore, the ink fixing in step S1006, the fixing detection of the tail end of the image in step S1007, the conveyance stop in step S1008, the heater temperature drop in step S1009, and the termination processing in step S1010 are similar to those in the case of FIG. 8.

On the other hand, when it is detected in S1002 that the cancel button is pressed (S1002=Yes), the ink ejection amount of the recording operation performed until the cancel is detected in S1011 is determined. The ink ejection amount which is low in risk of ink adhering to the inside of the recording apparatus even if the ink fixing operation is not performed is defined as a predetermined amount X, and when the ink ejection amount is equal to or less than the predetermined amount (S1011=Yes), the fixing operation is not performed. Then, the processing proceeds to steps S1009 and S1010 to complete the process. For this purpose, the CPU 005 counts the ink ejection amount in the recording operation, for example, for each scan, and stores the amount in the RAM 007. Then, when the cancellation is detected, the current ink ejection amount in the non-fixed area 503 is calculated on the basis of control information such as an encoder.

On the other hand, when the ink ejection amount is greater than X, it is determined that the fixing operation is needed. In step S1012, the temperature of the fixing unit 108 is lowered until the temperature reaches the temperature B lower than the temperature A. Thereafter, in step S1013, while keeping the temperature of the fixing unit 108 at the temperature B, the conveyance rollers are driven to convey the sheet 105, and the ink is fixed. It is determined in step S1014 whether the fixing has been completed to the tail end portion of the image data, and if it has not been completed (S1014=No), the processing in step S1013 is continued. When fixing of the ink to the tail end portion of the image data is completed (S1014=Yes), the processing proceeds to steps S1008 to S1010, and the processing is terminated. In the present flow, when the ink ejection amount is equal to or less than the predetermined amount, the fixing operation is not needed, so that costs such as power energy and time can be reduced.

In step S1011, the determination is made on the basis of the ink ejection amount, but the determination may be made on the basis of the type of sheet. In other words, the fixing operation may be omitted if the sheet 105 is easy to fix the ink. Further, the predetermined amount X may be changed depending on the type of the sheet 105, and the predetermined amount X may be increased, for example, when the sheet 105 is easy to fix the ink.

### Second Embodiment

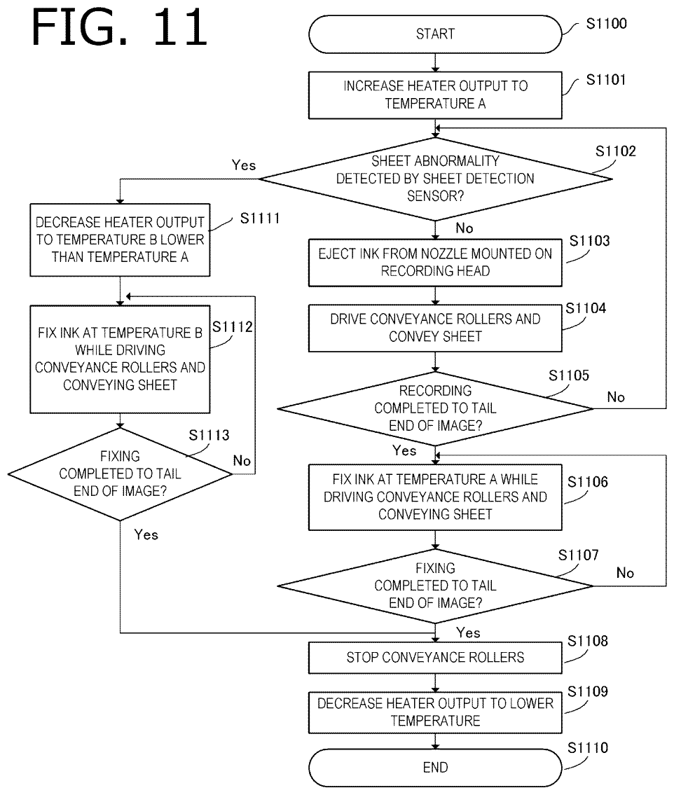

FIG. 11 is a flowchart illustrating processing of changing the fixation temperature when the recording is canceled according to a second embodiment. The same processing as in FIG. 8 will be explained briefly. The present embodiment is different from the above embodiment in that the trigger for stopping recording is not user cancellation but a detection result of a sensor. Each of the following steps is performed by the CPU 005 controlling each part of the device.

First, when the recording apparatus 004 receives image data in step S1100, processing is started. In step S1101, the temperature of the fixing unit 108 is raised to the temperature A. In step S1102, a sheet detection sensor 212 detects the sheet 105 and determines the state. In a case of an abnormal state (sheet presence) in which the sheet 105 is likely to contact the fixing unit 108 (S1102=Yes), the temperature of the fixing unit 108 is lowered until the temperature reaches the temperature B lower than the temperature A in step S1111. Thereafter, the processing proceeds to steps S1112 to S1110 in the same manner as in FIG. 8, and the processing is terminated.

When no abnormality is detected in the sheet 105 (S1102=No), the processing proceeds to steps S1103 to S1110 in the same manner as in FIG. 8, and the processing is terminated. According to the present embodiment, even if there is a sheet abnormality, it is possible to prevent ink from adhering to the inside of the recording apparatus.

Note that the presence or absence of an abnormality in the sheet 105 may be determined on the basis of whether or not a load more than necessary is applied to the carriage 101 and the conveyance rollers 205 and 206. Further, the control of the first embodiment may be appropriately applied to the present embodiment, such as reducing the conveyance speed of the sheet 105 when an abnormality is detected.

Conventionally, in a recording apparatus 004 that performs ink fixing using a fixing apparatus, if the conveyance operation and the fixing operation are immediately stopped when the user performs cancellation during recording or when a sheet abnormality occurs, there is a risk that the ink non-fixed portion remains in the recording apparatus. Therefore, when the user removes the sheet 105, ink may adhere to the inside of the recording apparatus, which may cause a failure. However, according to the configuration of each embodiment of the present disclosure, even when user cancellation or sheet abnormality is detected, the recording is not immediately stopped, but the ink is safely fixed by setting a fixation temperature lower than usual. Therefore, the user can remove the sheet 105 without staining the inside of the recording apparatus.

According to the present disclosure, it is possible to provide a technique for a user to remove the sheet without staining the inside of the recording apparatus when recording is stopped in the recording apparatus.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-137823, filed Aug. 19, 2024, which is hereby incorporated by reference herein in its entirety.

What is claimed is:

1. A recording apparatus comprising:
a recording unit configured to record an image on a recording medium;
a conveyance unit configured to convey the recording medium,
a fixing unit disposed downstream of the recording unit in a conveyance direction of the recording medium and configured to heat, at a first temperature, the recording medium on which the image has been recorded; and
a control unit configured to control the fixing unit, wherein
in case that image recording in a recording area by the recording unit is stopped before the image recording in the recording area by the recording unit is completed, the control unit is configured to change temperature of the fixing unit to a second temperature lower than the first temperature.

2. The recording apparatus according to claim 1, wherein
in case that stopping the image recording, the control unit is configured to fix, at the second temperature, ink in a non-fixed area that has been ejected onto the recording medium but has not yet been fixed by the fixing unit.

3. The recording apparatus according to claim 1, further comprising
a canceling unit configured to allow a user to cancel the image recording, wherein
the control unit is configured to stop the image recording in case that the user cancels the image recording.

4. The recording apparatus according to claim 3, wherein
in case that the user cancels the image recording, the control unit is configured to make speed at which the recording medium is conveyed slower than a normal conveyance speed.

5. The recording apparatus according to claim 3, wherein
in case that the user cancels the image recording, the control unit is configured not to perform a fixing operation on a non-fixed area if an amount of ink ejected on the non-fixed area which has been ejected onto the recording medium and has not yet been fixed by the fixing unit is equal to or less than a predetermined amount.

6. The recording apparatus according to claim 1, wherein
after stopping the image recording, the control unit is configured to convey an area on the recording medium where the image is recorded to a downstream side of the fixing unit in the conveyance direction.

7. The recording apparatus according to claim 1, further comprising
a detection unit disposed in a conveyance path of the recording medium and configured to detect whether there is an abnormality in the recording medium, wherein
the control unit is configured to stop the image recording in case that the abnormality in the recording medium is detected.

8. The recording apparatus according to claim 7, wherein
the detection unit is disposed downstream of the recording unit and upstream of the fixing unit in the conveyance direction of the recording medium, and is configured to detect an abnormality in case that the recording medium comes into contact with the fixing unit in a case where the recording medium is conveyed.

9. The recording apparatus according to claim 7, wherein
the detection unit is configured to detect an abnormality in case that the recording medium is jammed.

10. The recording apparatus according to claim 7, wherein
the detection unit is configured to detect an abnormality in cast that the recording medium is curled.

11. The recording device according to claim 1, wherein
the recording unit is a recording head configured to eject ink onto the recording medium and record the image.

12. The recording apparatus according to claim 1, wherein
the recording medium is a sheet roll that is a sheet wound around.

13. The recording apparatus according to claim 1, further comprising
a cutter disposed downstream of the fixing unit in the conveyance direction and configured to cut the recording medium on which the image has been recorded.
